(19) United States
(12) Patent Application Publication
(10) Pub. No.: US 2011/0016044 A1
(43) Pub. Date: Jan. 20, 2011

(54) Processes and systems employing multiple sources of funds

(76) Inventors: Craig Shapiro, Creve Coeur, MO (US); Kevin Krafve, Chesterfield, MO (US)

Correspondence Address: LEWIS, RICE & FINGERSH, LC;ATTN: BOX IP DEPT., 600 Washington Ave., Suite 2500, ST LOUIS, MO, 63101, US

(21) Appl. No.: 12/890,313

(22) Filed: Sep. 24, 2010

Related U.S. Application Data
(63) Continuation of application No. 11/480,031, filed on Jun. 30, 2006.
Application No. 11/480,031 is a continuation-in-part of application No. 10/748,710, filed on Dec. 30, 2003, now abandoned.

(51) Int. Cl. G06Q 40/00; G06Q 90/00

(52) U.S. Cl. 705/40; 705/500

(57) ABSTRACT

Processes and systems employing multiple sources of funds to fund expenses incurred during a project. Venders retained to perform services or supply goods during the project submit invoices for approval. Invoices are approved and verifications are obtained that verify that funds from a primary source of funds, such as a secured loan, are available to cover the invoices. Invoices are paid with funds from a secondary source of funds, such as an unsecured loan. The funds withdrawn from the secondary source are repaid with funds from the primary source. Use of the secondary source of funds enables for prompt and efficient payment of vendor invoices. The secondary source may provide other incentives for use in the project. During implementation, an eCommerce system facilitates prompt payments and provides status and alert information to the various parties involved, automatic procurement of lien releases, vendor on-line bidding capability and other functionality.

### RELATED APPLICATION

This is a continuation-in-part of U.S. patent application Ser. No. 10/748,710, filed Dec. 30, 2003. The disclosure of U.S. patent application Ser. No. 10/748,710, published as publication no. US2005/0144100 on Jun. 30, 2005, is incorporated herein by reference.

### BACKGROUND OF THE INVENTION

1. Field of the Invention

The present invention relates to processes and systems employing multiple sources of funds. More particularly, the present invention relates to processes and systems for utilizing funds from multiple sources to pay, in novel ways, expenses incurred during the course of a project.

2. Description of the Related Art

Currently, in the United States and also in many other countries around the world, monetary funds are borrowed by many businesses, almost on a daily basis, from external sources (e.g., banks) during the normal course of operations. Infrastructure is built and financed on borrowed money to achieve growth often not otherwise obtainable when hard currency must be used. As is well known, borrowing comes in various forms.

For example, certain debt instruments require a security interest in valuable property. These types of secured loans often are designed to be repaid over a relatively long period of time. Interest rates for such loans may be relatively low since they are secured by valuable property, which can be foreclosed upon in the event of default.

Other well-known types of loans are unsecured. Unsecured loans typically are short term and have relatively high interest rates as compared to secured loans. Consumer-type credit cards are well known types of unsecured loans. To encourage their use, banks and other credit card issuers have made credit cards convenient and easy to use. Moreover, most credit card issuers employ incentive programs, such as frequent flyer and rebate programs, to further encourage consumers to use credit cards, and also as a means for distinguishing one card from another.

These and other types of loans are employed differently in different industries. For example, in the construction business, a building contractor usually secures financing to pay for expenses, including materials and subcontractor services, that are incurred during the course of a project. With many construction loans, lending institutions release funds in pre-set increments to protect against theft or fraud by the contractor. In other instances, lending institutions engage title companies or escrow disbursing agents to facilitate payments to subcontractors and other third parties. Sometimes, lending institutions maintain a close watch on contractor activities. As a result of the foregoing, subcontractors and other entities frequently are paid for their services upwards of 60 to 90 days, if not more, after they have completed their contractual obligations. Moreover, since payment delays are common and thus perhaps expected by subcontractors, many contractors freely delay payments in order to finance other projects with borrowed money already earmarked for expenses previously incurred.

Vendors are particularly vulnerable to abuse in the construction business. Once work is completed, for example, a foundation poured, the work cannot be uncompleted nor can the vendor remove the materials supplied. Hence, there is a need for liens, which cause yet further delays in the process since lien releases or waivers must be procured during the course of a project.

As illustrated above, currently available construction type loans have certain shortcomings and often unintentionally encourage contractors to allocate borrowed funds improperly. Unfortunately, these problems do not exist solely in the construction business. Fraud, theft and excessive payment delays are rampant in many different types of projects in which services of third parties are utilized.

### OBJECTS AND SUMMARY OF THE INVENTION

In view of the foregoing, it is an object of the present invention to provide for various processes and systems that overcome or minimize the shortcomings associated with existing techniques for funding projects.

It is a further object of the present invention to enable vendors, subcontractors and other entities utilized in projects to be paid promptly.

It is another object of the present invention to prevent or minimize fraud or theft by the parties involved in a project.

It is yet a further object of the present invention to utilize loans to fund' a project in manners that provide additional incentives and benefits to the parties involved.

In accordance with one embodiment of the present invention, a process of utilizing multiple sources of funds to pay expenses incurred during a project comprises the steps of obtaining an invoice for payment, the invoice submitted by a vendor for rendering services for the project, obtaining verification that funds from a primary loan are available for the invoice, paying the invoice with funds from a secondary loan, and repaying the secondary loan with funds from the primary loan.

As one aspect of the present invention, the secondary loan is secured after the primary loan is secured.

As another aspect of the invention, the primary loan is secured by a borrower, and an entity distinct from the borrower verifies that funds from the primary loan are available for the invoice.

As a further aspect of the invention, the invoice is paid with funds from the secondary loan after verification is obtained that funds from the primary loan are available for the invoice.

As an additional aspect of the invention, the primary loan is secured by property relating to the project.

As yet another aspect of the invention, the secondary loan includes a term that restricts usage of the secondary loan to pay only invoices relating to the project funded by the primary loan.

As a further aspect of the invention, the secondary loan includes terms that permit usage of the secondary loan to pay both pre-approved and non-approved invoices. A pre-approved invoice corresponds to an invoice in which verification that funds from the primary loan are available for the respective invoice is obtained. A non-approved invoice corresponds to an invoice in which no verification is obtained.

As a feature of this aspect, the secondary loan includes a term corresponding to no pre-set spending limit for paying pre-approved invoices, and the secondary loan includes a term corresponding to a pre-set spending limit for paying non-approved invoices.

As a further feature of this aspect, the secondary loan includes a term corresponding to a first pre-set spending limit for paying pre-approved invoices, and the secondary loan includes a term corresponding to a second pre-set spending limit for paying non-approved invoices. The first and second pre-set spending limits are different. As a particular feature, the first pre-set spending limit is substantially greater than the second pre-set spending limit.

As another feature of this aspect, the secondary loan includes a term corresponding to a first payment window during which funds borrowed from the secondary loan to pay pre-approved invoices may be paid without incurring interest, and the secondary loan includes a term corresponding to a second payment window during which funds borrowed from the secondary loan to pay non-approved invoices may be paid without incurring interest. The first and second payment windows are different. As a particular feature, the first payment window is substantially shorter than the second payment window.

As a further aspect of the invention, funds are transferred from the primary loan to a separate account.

As another aspect of the invention, the secondary loan is repaid by transferring funds from the separate account into an account that corresponds to the secondary loan.

As an additional aspect of the invention, funds are transferred from the primary loan to the separate account prior to paying the invoice with funds from the secondary loan.

As yet a further aspect of the invention, funds are transferred from the primary loan to the separate account after paying the invoice with funds from the secondary loan.

As yet an additional aspect of the invention, authorization from a title company to pay the invoice is obtained prior to paying the invoice.

As still yet a further aspect of the invention, authorization is obtained from the title company after verification is made that funds from the primary loan are available for the invoice.

As still yet another aspect of the invention, a title company transfers funds from the primary loan to a separate account, and the invoice is paid after the title company authorizes payment.

As still yet an additional aspect of the invention, the invoice is paid by providing the vendor with a code and payment is made after the vendor provides the supplied code.

As a feature of this aspect, the primary lender supplies the vendor with the code, and the vendor supplies the code to the secondary lender for payment.

As a further feature of this aspect, a title company supplies the vendor with the code.

As another aspect of the present invention, the borrower repays the primary loan.

In accordance with another embodiment of the present invention, a process of utilizing multiple sources of funds to pay expenses incurred during a project comprises the steps of obtaining an invoice for payment, the invoice submitted by a vendor for rendering services for the project, obtaining verification that funds from a primary fund source are available for the invoice, paying the invoice with funds from a secondary fund source, and repaying the secondary fund source with funds from the primary fund source.

Various aspects and features of this embodiment of the present invention include those aspects and features mentioned above with respect to the first embodiment.

In addition, as another aspect of this embodiment, the primary fund source is a grant of funds and the secondary fund source is a loan secured from a lending institution.

As a further aspect of this embodiment, the primary fund source is for the benefit of a funds recipient, and an entity distinct from the funds recipient verifies that funds from the primary fund source are available for the invoice.

In accordance with a further embodiment of the present invention, a process of utilizing multiple sources of funds to pay expenses incurred during a project comprises the steps of electronically approving an invoice submitted by a vendor for rendering services and/or goods for the project, paying the invoice with funds from a secondary fund source, and repaying the secondary fund source with funds from the primary fund source.

Various aspects and features of this embodiment of the present invention include those aspects and features mentioned above with respect to the first and second embodiments.

As another aspect of this embodiment, the vendor electronically submits the invoice.

As a further aspect of this embodiment, a lien waiver for the vendor is electronically generated.

As a feature of this aspect, the lien waiver is automatically generated by an electronic system after the invoice is paid.

As another feature of this aspect, the lien waiver is automatically generated prior to paying the invoice.

As a further feature of this aspect, the lien waiver is pre-authorized by the vendor. In particular, the lien waiver is pre-authorized prior to approving the invoice.

As an additional feature of this aspect, the lien waiver is automatically generated by utilizing electronic data previously supplied in an electronic work request for the vendor.

As another aspect of this embodiment, the funds recipient accesses work request status information about the project via an electronic system. The work request status information represents statuses of work requests for plural vendors involved or sought to be involved in the project.

As a feature of this aspect, the work request status information identifies a first number of vendors associated with respective work requests having a first status, and a second number of vendors associated with respective work requests having a second status. The first and second statuses are different.

As a feature of this feature, the first status is a status selected from the group consisting of new work request, requested work request, done work request and completed work request, and the second status also is a status selected from the group consisting of new work request, requested work request, done work request and completed work request. The first status and the second status are different.

As another feature of this aspect, the work request status information accessible to the funds recipient includes information representing, for each of plural projects of the funds recipient, statuses of work requests of vendors involved or sought to be involved in the respective project.

As yet another aspect of this embodiment, the funds recipient accesses via the electronic system information about each of plural projects in which the funds recipient is involved.

As a feature of this aspect, the information accessible includes, for each project, an identity of the respective primary fund source and a respective balance of funds available from the respective primary fund source.

As yet a further aspect of this embodiment, a vendor accesses via the electronic system work request status information identifying statuses of plural work requests associated with the vendor for the project.

As yet an additional aspect of this embodiment, a vendor accesses via the electronic system work request status information identifying, for each project, statuses of work requests associated with the vendor for the respective project.

As still yet another aspect of this embodiment, the primary fund source accesses via the electronic system lien information identifying, for each project in which the primary fund source supplies funds, statuses of the lien of each vendor involved in the respective project.

As still yet a further aspect of this embodiment, the electronic system includes online bidding on a work request relating to the project by plural vendors.

As a feature of this aspect, online bidding allows selected vendors to bid on the work request. Selected vendors may include only vendors that have a relationship with the secondary fund source.

As another feature of this aspect, online bidding includes providing via the electronic system, by plural bidding vendors, bids including documents comprising at least blueprints, drawings and/or specifications.

Various other objects, advantages and features of the present invention will become readily apparent to those of ordinary skill in the art, and the novel features will be particularly pointed out in the appended claims.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 is a block diagram showing the various parties involved in projects in accordance with an embodiment of the present invention;

FIG. 2 is a flowchart showing the general process of utilizing multiple loans in accordance with the present invention;

FIG. 3 is a block diagram showing the various parties involved in projects in accordance with another embodiment of the present invention;

FIG. 4 is a flowchart showing the general process in accordance with the embodiment addressed in connection with FIG. 3;

FIG. 5 is a block diagram showing the various parties involved in projects in accordance with a further embodiment of the present invention;

FIG. 6 illustrates an exemplary budget table accessible by a primary borrower via the eCommerce system of the present invention;

FIG. 7 shows an exemplary page of information that is electronically accessible by a vendor via the eCommerce system of the present invention;

FIG. 8 shows an exemplary lien waiver automatically generated by the eCommerce system of the present invention;

FIG. 9 shows the exemplary lien waiver shown in FIG. 8, particularly identifying select fields automatically populated by the eCommerce system of the present invention;

FIG. 10 shows another exemplary page of information accessible by the primary borrower via the eCommerce system of the present invention, particularly identifying multiple projects of the primary borrower;

FIG. 11 shows another exemplary page of information accessible by a vendor via the eCommerce system of the present invention, particularly identifying multiple projects in which the vendor is involved;

FIG. 12 shows an exemplary page of information accessible by a primary lender via the eCommerce system of the present invention; and

FIG. 13 shows an exemplary page pertaining to an online bidding feature of the present invention.

### DETAILED DESCRIPTION OF PREFERRED EMBODIMENTS

The various embodiments disclosed herein entail processes and systems that employ multiple sources of funds in unique manners that achieve various beneficial and/or advantageous results to the parties involved. Particular embodiments include the use of a secured loan and a separate, unsecured loan. In various embodiments, expenses for goods and/or services are paid using funds from a secondary loan followed by repayment of the secondary loan using funds from a primary loan.

In these and other embodiments, a secondary loan is used to enable efficient payment for expenses. In various embodiments, a secondary loan is used to pay for expenses for which a primary loan was procured and also to pay for unrelated expenses. Various embodiments provide incentives (e.g., reward points) to borrowers and other parties.

The present invention also includes an eCommerce system to facilitate prompt payments. The eCommerce system provides, among other things, valuable status and alert information to the various parties involved, automatic procurement of lien releases, and vendor on-line bidding capability.

Each of the embodiments of the present invention entails multiple parties or entities. In general, each of the embodiments pertain to the use of two different sources of funds during the course of carrying out one or more projects, jobs, developments, tasks, etc. In certain embodiments, the two sources of the funds (e.g., two banks) have a particular relationship or arrangement with one another to ensure that the features and benefits of the various inventive processes described herein are realized. In certain embodiments, funds from multiple sources are allocated to a borrower (also called “primary borrower” or “funding recipient” herein) who utilizes the funds in various novel manners to be described.

Each of the embodiments described herein involve some or all of the following parties: (a) a primary borrower of funds; (b) a primary lender of funds; (c) a secondary lender of funds; (d) one or more vendors; (e) a grantor of funds; (f) a title company; and (g) a management company. Each of these parties may be an individual or a company. Each company may be a sole proprietorship, partnership, corporation or other type of organization. A party may be a combination of these types of entities. For example, the primary borrower may be two or more companies or individuals collectively involved in a project. As another example, a secondary lender may include a company and sister companies involved or assisting with the loan to the primary borrower. The roles and functions of each of the parties are further discussed below.

Various terms used herein, including but not limited to “primary” as in “primary borrower,” “primary lender” and “primary grantor,” and “secondary” in “secondary lender,” are for convenience only to distinguish one lender from another lender, one borrower from, if any, another borrower, etc. Hence, such terms are not to be construed to designate relative importance, size, occurrence in time or other comparative quality, unless otherwise stated explicitly. Moreover, the terms of each of the parties designate the function or role of a party within the various embodiments described and do not necessarily designate the general function of such entity. For example, an entity carrying out the functions of the primary lender as described herein may, in fact, be an entity that usually does not lend funds.

The inventive processes and systems of the present invention seek to provide various features and benefits. In particular, various embodiments utilize funds provided from multiple sources to be distributed or otherwise transferred to various parties. Features and benefits of the novel processes and systems described herein include quicker payment of funds to vendors, the distribution of incentives to the primary borrower for the use of the funds, the ability to conduct transactions and carry out various processes electronically, such as via the Internet, the ability to electronically provide information, such as budgets, payment data and lien status information, to the various parties involved in an efficient and real-time manner, the automatic generation and transmission of lien releases, automatic notification of alerts and status information, including payment alerts, and online bidding. These and other features, variations and benefits are further discussed below.

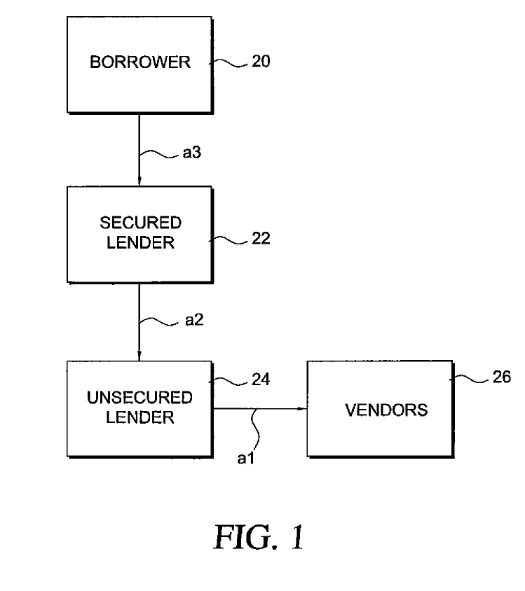

Referring now to the drawings and particularly to FIG. 1 thereof, a block diagram of the various parties in accordance with one embodiment of the present invention is shown. The parties involved are a primary borrower 20 (or, simply, “borrower” or “funding recipient”), a secured lender 22, an unsecured lender 24, and one or more vendors 26. For convenience, reference to “vendor” refers to any suitable vendor or multiple vendors, unless otherwise stated.

Initially, borrower 20 arranges with secured lender 22 for a loan (called “primary loan” or “secured loan” herein) that is secured by property owned by borrower 20 (or a third party guarantor). The primary loan preferably is obtained for the purpose of securing funding for expenses to be incurred during the course of a project, construction, job or other effort of borrower 20. The property that is offered as collateral to secured lender 22 may relate to the project of borrower 20 for which the primary loan is being obtained.

Borrower 20 also arranges with unsecured lender 24 for an unsecured loan of funds (called “secondary loan” or “unsecured loan” herein) to be drawn upon for the purpose of directly paying for goods and/or services rendered by vendors 26.

In accordance with the present invention, prior to allocating funds from the unsecured loan for payment of expenses incurred by borrower 20, secured lender 22 verifies that funds from the secured loan are available and earmarked to repay the funds about to be drawn from the unsecured loan. More particularly, secured lender 22 and unsecured lender 24 enter into a contractual arrangement that requires invoices submitted by vendors to be first authorized (called, for convenience only, “pre-authorized” or “pre-approved” herein) by secured lender 22 (or other designated entity) prior to the release of funds from the unsecured loan to pay the submitted invoices.

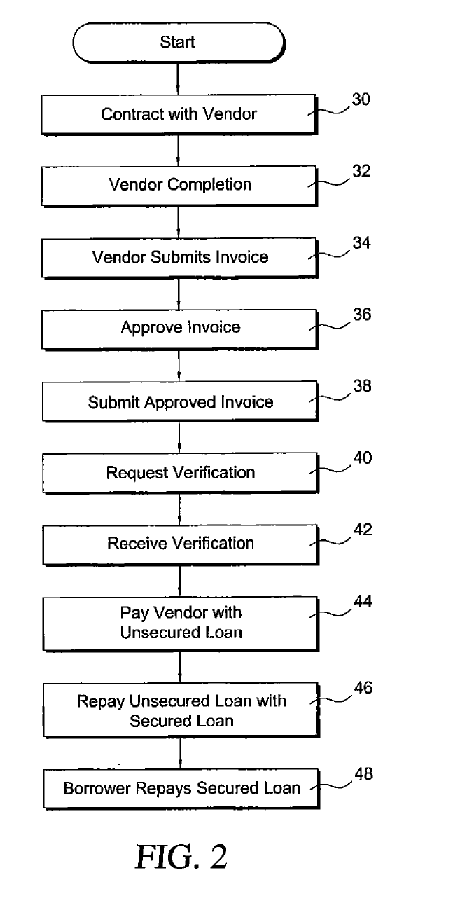

FIG. 2 is a flowchart that shows the general process of the present invention. During the course of the borrower's project, borrower 20 contracts with a vendor 26 in any manner for goods and/or services (step 30). After vendor 26 completes its services or supplies goods (or completes a phase of services) (step 32), vendor 26 submits to borrower 20 an invoice for the goods or services rendered (step 34). Borrower 20 approves the invoice (step 36) and submits the approved invoice to the unsecured lender 24 for payment (step 38). Unsecured lender 24 then requests that secured lender 22 verify (or “pre-approve”) that funds are available from the secured loan to repay the expense (step 40). Upon receiving the verification (step 42), unsecured lender 24 pays the verified invoice (or “pre-approved invoice”) with funds drawn from the unsecured loan (represented by arrow a1 in FIG. 1; step 44 in FIG. 2).

As a variation, rather than borrower 20 submitting the approved invoice to the unsecured lender 24 for payment (step 38) and unsecured lender 24 requesting that secured lender 22 verify (or “pre-approve”) that funds are available, as described above, borrower 20 submits the invoice directly to secured lender 22 and secured lender 22 in turn authorizes unsecured lender 24 to pay the invoice.

Shortly after paying vendor 26, funds borrowed from unsecured lender 24 are repaid using funds drawn from the secured loan (represented by arrow a2 in FIG. 1; step 46 in FIG. 2). Alternatively, funds borrowed from unsecured lender 24 are repaid after the unsecured lender issues a statement of amount owed (e.g., a monthly statement).

Borrower 20 periodically repays a portion of the amount owed to secured lender 22 (represented by arrow a3 in FIG. 1; step 48 in FIG. 2). In general, borrower 20 repays a portion of the principal owed along with interest that has accrued. The process shown in FIG. 2 is repeated for other vendors (occurring simultaneously and/or sequentially).

Various embodiments of the present invention are particularly well suited to be utilized within the building construction business. As is well known, construction typically entails the use of subcontractors who hope to be paid promptly. Usually, a subcontractor submits to a contractor an invoice (or a final invoice) at the completion of the subcontractor's contractual obligations. Unfortunately, for various reasons including those identified above, subcontractors often must wait several months before being paid for their services. The present invention, on the other hand, minimizes payment delays by employing multiple sources of funds in the manners described herein.

As would be appreciated, the construction business is just one type of business in which the present invention may be employed. For purposes of the explanations and discussions presented herein, it should be understood that the primary borrower may be a general contractor, a builder, an individual, a municipality, or other type of organization. The borrower's business or project, job, development or task may be a construction project, such as a building construction project, a ship construction project, an electronic system, such as a computer, optical or other type of network, system, device, etc., an environmental project, a manufacturing effort, a research and development project, a theatrical production (e.g., cinematic, television, musical, etc.) or any other project, task or job generally requiring the use of multiple vendors for goods and/or services.

Vendors include sellers (e.g., retailer, wholesalers, etc.) or licensors of goods, including but not limited to machinery, parts, vehicles, commodities, real property, heavy equipment, materials, petroleum, factories, buildings, and office space. Vendors also include providers of services, including but not limited to subcontractors, travel related service entities (e.g., airlines, etc.), other rental agencies (e.g., camera rentals, etc.), employees, performers and crews (e.g., for theatrical productions, including both labor and materials, etc.), payroll services and consultants. For convenience, references to “services,” “rendering services,” “services rendered” or other similar terms shall include the sale, lease or otherwise providing or use of goods, whether tangible or intangible.

As discussed in the various embodiments described, vendors submit invoices for payment. The term “invoice” or “invoices” includes a document or communication for payment of goods and/or services rendered or to be rendered, including a portion of services rendered or to be rendered (e.g., completion of a phase of a service). Invoices include, but are not limited to, a bill, a contract, or other document or communication, whether in tangible or intangible form, indicating that a payment is due. Moreover, references to submission of an invoice for payment by a vendor shall include an expectation by a vendor for payment, such as in the case of when a periodic (e.g., monthly) payment to, for example, a consultant is due.

The primary lender may be a bank or other lending institution. The primary lender may be an individual or entity that is simply operating in the capacity of the primary lender as described herein. For example, a primary lender may be a private investor or a group of investors.

The primary lender may provide funds to a borrower in accordance with the present invention with terms that include a relatively low interest rate, especially if the loan is secured by valuable property. The amount of the primary loan may be any size and depends on the scope and size of the project, the value of the collateral (if the loan is to be secured) and other factors. In a variation, rather than providing a primary loan to the borrower, funds may be given, donated or otherwise supplied to the borrower (such as in the foundation grant embodiment described below). In such case, the supplier of such funds operates in the capacity of the primary lender discussed herein.

The secondary lender may be, like the primary lender, a bank or other lending institution, but also may be another entity operating in such capacity. The secondary loan offered by the secondary lender preferably, although not necessarily, is a line of credit.

The primary and secondary lenders are distinct and unrelated entities. In a variation, the primary and secondary lenders are related.

During implementation, the borrower draws upon funds from the secondary loan as the need arises during the course of the project, as described above. In one preferred manner of implementation, funds are transferred from the secondary lender to the vendor by wire transfer. In a variation, funds are transferred in another manner, such as by delivery of a certified check or other known technique for transferring funds. In yet another variation, the secondary loan operates similar to a credit card account in which the vendor processes a “charge” to that credit card-like account for the amount of the approved invoice.

In any of the variations mentioned herein, the borrower is prohibited from utilizing funds from the secondary loan for expenses not associated with the project for which the primary loan was provided. In a variation, the borrower is permitted to draw upon the secondary loan to pay for expenses associated with different projects, so long as the primary lender pre-approves each of those expenses. Different primary lenders may be employed for different projects and, in such case, the respective primary lender for the submitted expense must pre-approve that expense. In these situations, the primary lender or primary lenders guarantee repayment to the secondary lender for each expense incurred on those different projects. For each of these variations, however, there is no need for the secondary lender to place a limit on the amount of funds that can be withdrawn from the secondary loan since the primary lender (or lenders) has already guaranteed repayment of such expenses.

In another variation, the borrower is permitted to utilize the secondary loan to pay for any expense, whether related or unrelated to a project for which the primary loan was given, subject to specific restrictions and terms as set forth by the secondary lender. In the case of use of the secondary loan to pay for expenses related to the project for which the primary loan was given, the borrower's use of the secondary loan is subject to pre-approval for such use, as already described above. For other expenses, that is, for expenses not pre-approved (also called herein, for convenience, “non-approved expenses” or “non-approved invoices”), the borrower's use of the secondary loan is subject to terms set forth by the secondary lender and, in such case, may be similar to terms of existing credit card accounts. For example, if a borrower desires to draw upon funds from the secondary account to pay for non-approved expenses, the borrower may do so as long as the account's pre-set spending limit (for non-approved expenses), if one exists, is not reached.

Manners of implementation of using the secondary account to pay for non-approved expenses include instructing the secondary lender to pay the non-approved expense, subject to terms and conditions as discussed below. If the secondary account operates in a manner similar to a credit card account, as mentioned above, the borrower may authorize a vendor to charge the account (e.g., using the vendor's card processing terminal or other known manner to charge an expense to a credit card account).

Terms and conditions of the secondary loan for repayment of funds borrowed to pay for non-approved expenses preferably are different than for pre-approved borrowed funds. In particular, the interest rate for late repayment may be different. In the case of funds drawn to pay for pre-approved expenses, the interest rate for late payment (i.e., paid after the interest free payment window discussed below) may be relatively low or even zero since the primary lender guarantees repayment and, as discussed below, may be obligated to do so promptly. On the other hand, the interest rate for late payment of funds drawn to pay for non-approved expenses preferably is relatively high.

The secondary loan preferably has a pre-set maximum limit for funds drawn to pay for non-approved expenses. On the other hand, no maximum limit is required (optionally, one can be set) for pre-approved expenses since the primary lender guarantees repayment of funds drawn for pre-approved expenses. The secondary loan also preferably has different interest free repayment periods or windows (also called “interest free payment window”) in which no interest is accrued if the secondary loan is repaid in full. That is, a first interest free payment window is designated (e.g., 30 days) for the repayment of non-approved expenses and a second interest free payment window is designated (e.g., 15 days) for the repayment of pre-approved expenses.

In a preferred embodiment of the invention, the interest free payment window for repayment of pre-approved expenses is relatively small, for example, 5 days, 10 days, 15 days, etc., as compared to the interest free payment window for repayment of non-approved expenses, in order to financially encourage lending institutions, such as credit card issuers, to issue secondary loans in accordance with the present invention. More specifically, by providing a relatively small interest free payment window in which the primary lender must repay the secondary lender for funds allocated to pay for pre-approved expenses, expenses incurred by the secondary lender to facilitate the payment of pre-approved expenses are minimized.

In accordance with another embodiment of the present invention, the secondary lender provides incentives to the borrower for use of the secondary loan. Such incentives may be in the form of reward points that are accumulated based upon usage of the secondary loan and that are redeemable for something of value, such as cash rebates, mileage in various airlines' frequent flyer programs, and specified goods and services. In a variation, reward points accrued for payment of a vendor invoice are provided to both the borrower and the vendor associated with the paid invoice, to further encourage vendor acceptance of payments made in accordance with the present invention.

In certain embodiments described above as well as below, and particularly embodiments described with reference to FIGS. 1 and 2 of the drawings, the primary loan is a loan secured by valuable property. Although generally not preferred, in a variation of these embodiments, neither the primary loan nor the secondary loan is secured. In yet a further variation, the primary loan is unsecured and the secondary loan is secured.

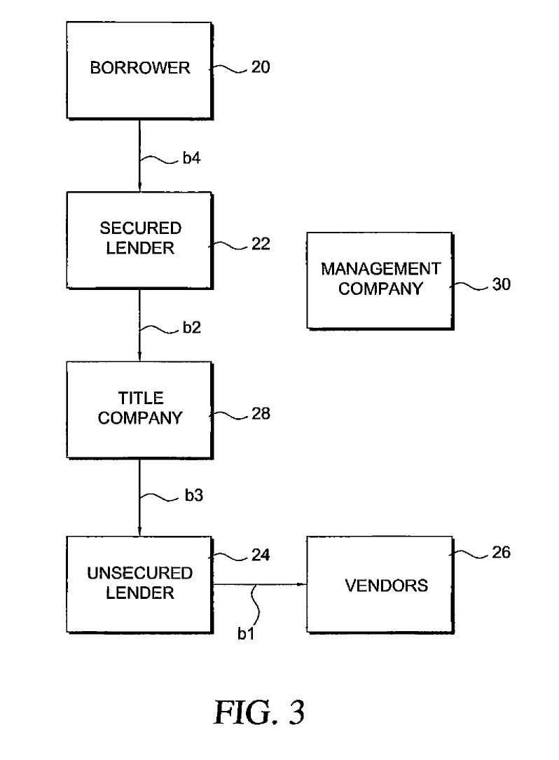

Referring now to FIG. 3, a block diagram showing the various parties in accordance with a further embodiment of the present invention is shown. FIG. 3 is similar to FIG. 1, but further shows a title company 28 and a management company 30 (also called “sponsor”). Title company 28 operates as a third party intermediary between the primary lender (e.g., secured lender 22) and the secondary lender (e.g., unsecured lender 24). More particularly, title company 28 provides assurances to the secondary lender that funds from the primary loan are available to repay funds withdrawn from the secondary loan to pay pre-approved expenses. The title company, as understood herein, may be an escrow company, a disbursing entity (e.g., a payroll company, etc.) or other type of company implementing the functions of the title company described herein.

Management company 30 is further discussed below.

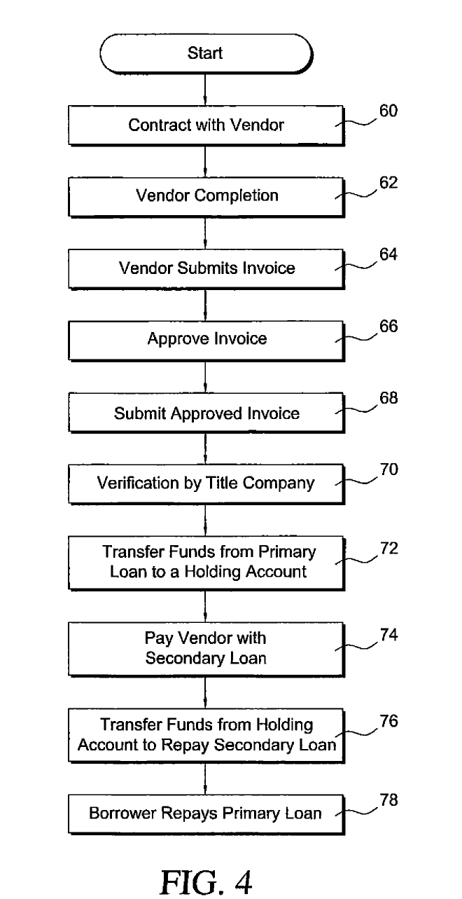

Referring to the flowchart shown in FIG. 4, borrower 20 contracts with a vendor 26 (step 60), and vendor 26, upon completion of its services (or completion of a phase, or transfer of goods) (step 62), submits an invoice for payment (step 64). Borrower 20 approves the invoice (step 66) and submits the invoice to title company 28 (step 68). In a variation, after borrower 20 approves the invoice, an electronic invoice is created and sent back to the vendor for the vendor's approval. The vendor approves the electronic version of the invoice and authorizes a lien release (further discussed below) and, thereafter, the approved invoice is forwarded, preferably electronically, to the title company.

The title company verifies that funds from the primary loan are available and earmarks funds for the expense (step 70). The title company then authorizes the secondary lender to pay the invoice (represented by arrow b1 in FIG. 3; step 74 in FIG. 4). The title company may additionally, prior to, during or after authorizing the secondary lender, transfer (or arrange for the transfer of) the funds earmarked in the primary loan to a separate account (e.g., temporary holding account) (represented by arrow b2 in FIG. 3; step 72 in FIG. 4). Preferably, the separate account is accessible only by the title company and bears interest.

After the invoice is paid with funds from the secondary loan, the funds borrowed from the secondary loan are repaid with funds drawn from the primary loan. If such funds were transferred to a separate account, then the transferred funds are used to repay the secondary loan (represented by arrow b3 in FIG. 3; step 76 in FIG. 4). Repayment of the secondary loan preferably is made within the secondary loan's interest free payment window, if one exists. In a variation, repayment is made promptly, for example, within a few days of payment of the vendor invoice. In another variation, repayment is made after receiving the secondary lender's account statement. Borrower 20 repays the primary loan over time (represented by arrow b4 in FIG. 3; step 78 in FIG. 4). The process shown in FIG. 4 is repeated for other vendors (simultaneously and/or sequentially).

In a variation of the above-described embodiments, the title company provides the vendor, preferably electronically, with an authorization (or approval) code. The vendor then provides the authorization code to the secondary lender-who, upon receipt of a proper authorization code, pays the approved invoice.

In accordance with another embodiment of the present invention, the title company or, alternatively, the primary lender, secures a lien release, if necessary, from the vendor prior to or upon payment of the vendor invoice. As is well known, in various industries, including the construction business, various subcontractors and other vendors obtain liens on property and, thus, a lien release (or lien waiver) must be procured for each such vendor. In an embodiment described below, particularly involving the use of eCommerce, the present invention advantageously provides for the automatic generation of lien releases.

In accordance with a further embodiment, a management company 30 shown in FIG. 3 operates to control and assist in coordinating the operations of the various processes and systems of the present invention. The management company can assist in recruiting borrowers, lenders and vendors to take part in various programs carried out in accordance with the present invention. The management company can provide services exclusively to participants in such programs. The management company can negotiate terms or discounts on behalf of members.

The management company further can establish and maintain quality control to ensure that a level of quality of services is being provided amongst the entities involved. The management company can regulate membership, including restricting membership in programs carrying out the present invention to select companies.

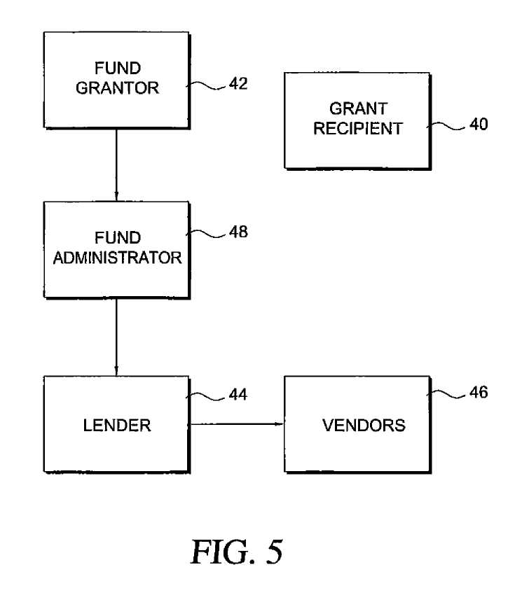

Referring now to FIG. 5 of the drawings, a block diagram showing the various parties in accordance with another embodiment of the present invention is shown. In this embodiment, funds are principally obtained through the donation or grant by a third party entity, herein identified as fund grantor 42. The fund grantor may be an individual, a group of individuals, a not-for-profit organization, a for-profit entity, a government entity, a university, a research foundation or any other organization. The grant by fund grantor 42 can be (but not limited to) voluntary, discretionary or as a result of a mandatory government or private program. As would be appreciated, fund grantor 42 in this embodiment replaces as the primary source of funds the primary lender of the various other embodiments discussed herein.

Grant recipient 40 (also called “funding recipient”) receives a grant from fund grantor 42 and generally functions in a manner similar to borrower 20 discussed in other embodiments. In accordance with the present invention, grant recipient 40 arranges with a lender 44 for a loan, secured or unsecured, to facilitate prompt and efficient payments to vendors 46 during a project to be performed. In accordance with this embodiment, a fund administrator 48 operates in a similar capacity as title company 28 previously discussed and carries out at least the function of verifying that funds from fund grantor 42 are available and earmarked for vendor invoices.

Lender 44 operates in a similar capacity as the secondary lender or the unsecured lender previously discussed. Similar to such other embodiments, lender 44 and fund administrator 48 enter into an agreement wherein lender 44 provides a loan, preferably a line of credit, to grant recipient 40 on terms and conditions similar to those of the unsecured loans previously discussed. Approvals, verifications and payments are made in accordance with any embodiment described herein, with the exception that the funds provided by fund grantor 42 do not need to be repaid.

In a variation of the embodiments described, the funds recipient (e.g., primary borrower) may opt to use its own funds to fund a project in accordance with the present invention. In such case, and with reference to FIG. 5, fund grantor 42 and grant recipient 40 are the same entity. By employing the present invention, a builder, contractor or other entity using its own funds to pay expenses for a project of some sort still realizes and enjoys the advantages and benefits as described herein. For example, prompt payment to vendors and other features are realized by the use of a lender 44, as previously discussed.

In the various embodiments described herein, interest may be accrued during select periods of time. For instance, in the embodiment in which funds from the primary loan are placed in a separate account prior to being used to repay the secondary loan, interest will accrue if the separate account is interest bearing. In such case, the accrued interest is paid to the title company in exchange (or partially in exchange) for the services it renders. In a variation, the accrued interest is paid to the secondary lender. In yet another variation, the accrued interest is split amongst two or more of the various parties involved in the project. Interest accrued, if any, by funds held by the primary lender during the period from when the secondary lender pays a vendor invoice to when the secondary lender is repaid may likewise be distributed to one or more parties involved in the project. In each of the different embodiments described, distribution of any accrued interest preferably is distributed to one or more parties, possibly including the borrower, vendors and/or management company, in manners that maximize participation by the different types of entities in programs carrying out the present invention.

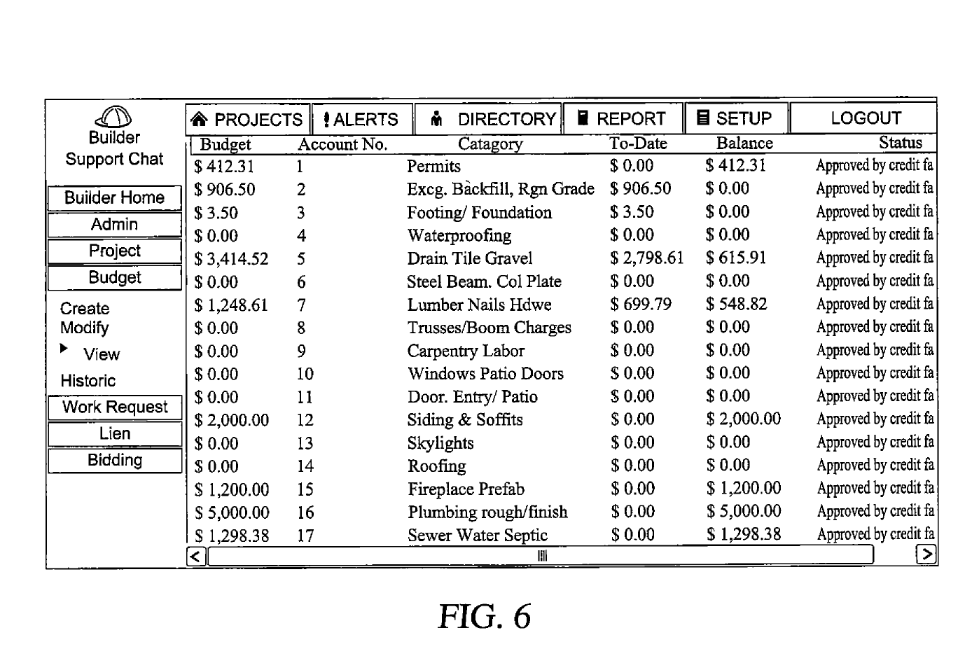

FIGS. 6 through 13 show various exemplary images displayed on computers or other suitable electronic devices (e.g., PDAs) of various parties, as described below, employing systems that carry out or assist in carrying out the present invention. Since it would be well within the ability of those of ordinary skill in the art to provide software and hardware suitable to facilitate the various features described herein given the discussion set forth, details of such software and/or hardware are not provided. The use of computers and other electronic devices and suitable software to carry out the features and embodiments discussed herein is, for convenience, referred to as the eCommerce system (also eCommerce process) of the present invention. As described below, the eCommerce system of the present invention facilitates the completion and processing of purchase orders, vendor contracts, electronic lien releases, vendor invoices and other aspects of projects carried out by borrower 20 or grant recipient 40. In particular, the eCommerce processes described herein are paperless and efficient and entail the use of online budgets, work requests, invoices, electronic liens, real time status information, instant alerts and notifications to the multiple parties involved, and online bidding, as further discussed below.

In accordance with the present invention, the eCommerce system enables contractors, builders and other such fund recipients to create a project within the eCommerce system. From that point on, the fund recipient is electronically linked with its sources of funds as well as the vendors.

FIG. 6 illustrates an exemplary budget table preferably securely accessible by the borrower (or grant recipient) via the Internet or secured Intranet or other known method. In the exemplary budget table shown, the borrower is a builder wherein FIG. 6 represents the builder's budget page in the eCommerce system of the present invention. As features of the invention, the budget table can be created, viewed and modified by the builder. The budget table shown includes plural line items, each representing a specified expense to be incurred or already incurred. For each line item, the budget table identifies in the “Budget” column the original budget amount designated for the respective expense, identifies in the “Category” column a description of the respective expense, identifies in the “To-Date” column the amount of expense incurred to date, identifies in the “Balance” column any remaining budget for that expense, and identifies in the “Status” column the approval status for that expense.

The budget table may include additional information, such as the identity of the vendor to supply the goods to be obtained or services to be rendered. The budget table may further identify dates of completion of services or purchase of goods, as well as other information generally useful to a builder. For other types of projects, the information provided in the budget table may differ from that shown in FIG. 6.

In accordance with the present invention, the budget table is accessible by the borrower (e.g., builder) and the title company and/or the primary lender. The title company preferably has limited capability to modify the budget table. For example, the title company preferably is able to modify the status of an identified expense to indicate that an expense is approved (or not approved).

As further discussed below, the builder also has access to tables showing all of the projects in which it is involved, vendor work requests, lien information, and bidding tables. With regard to work requests, the eCommerce system compares each work request created by the builder with the project's budget to ensure that projects remain on budget or there is proper notification and authorization if the original budget must be exceeded.

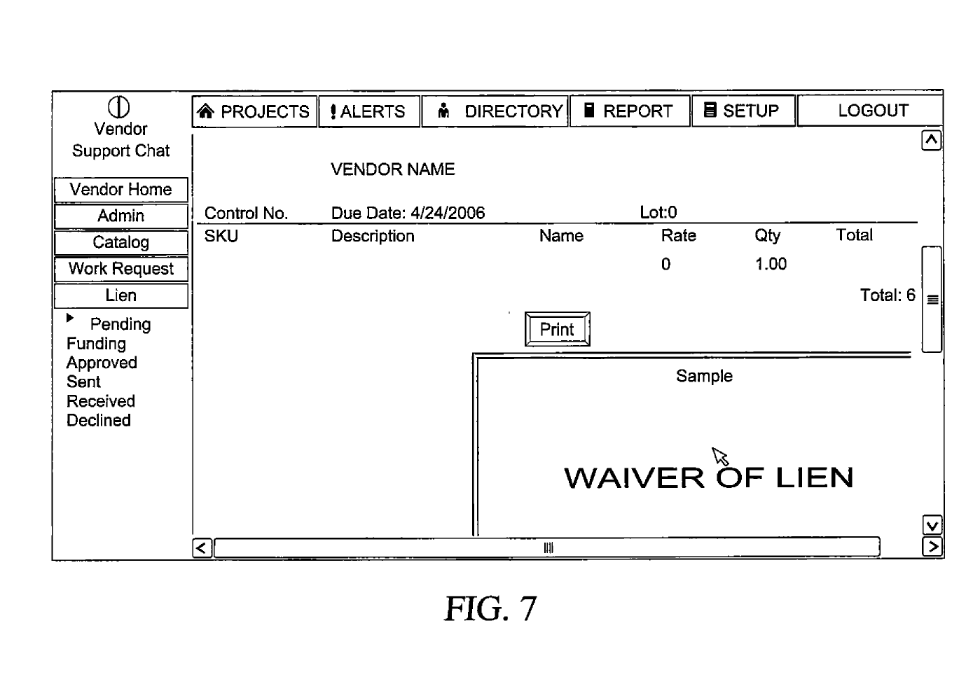

FIG. 7 shows an exemplary electronic work request/purchase order page that is accessible by a vendor. In accordance with the present invention, vendors participating in programs implementing the present invention are authorized to electronically access (e.g., using a supplied password) the eCommerce system of the present invention. One feature of the eCommerce system is the electronic creation of a work request, generally by the builder (but also may be created by a vendor), followed by the subsequent notification of that work request to the identified vendor. The vendor may be identified in any known manner, such as by mail, telephone, e-mail, etc. Upon receipt of the notification, the vendor logs into the eCommerce system of the present invention to access the work request and either accepts or rejects it. The vendor's response is supplied to the builder, being identified on one of the pages accessible by the builder via the eCommerce system of the present invention.

As discussed further below, the information supplied in the work request or purchase order, by the builder and/or vendor, form the basis for further functionality of the eCommerce system of the present invention. In particular, the information supplied in the work request enables for the automatic creation of the lien waiver and also for the automatic electronic “check requisition” as the various payment approvals are made in accordance with the present invention.

Upon the vendor's completion of its contractual obligations, the vendor provides an invoice along with a lien waiver (also called lien release) via the eCommerce system, such as shown in FIG. 7.

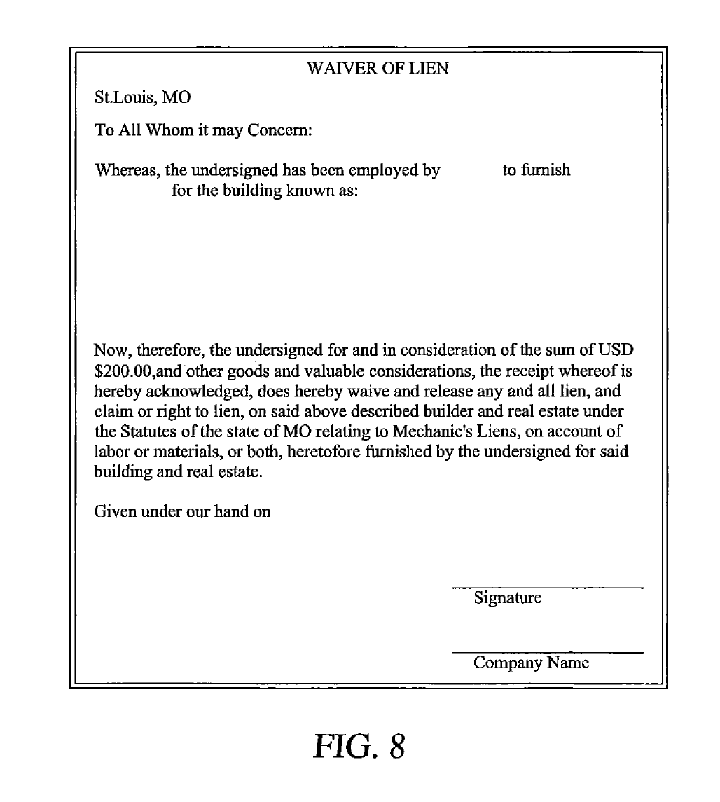

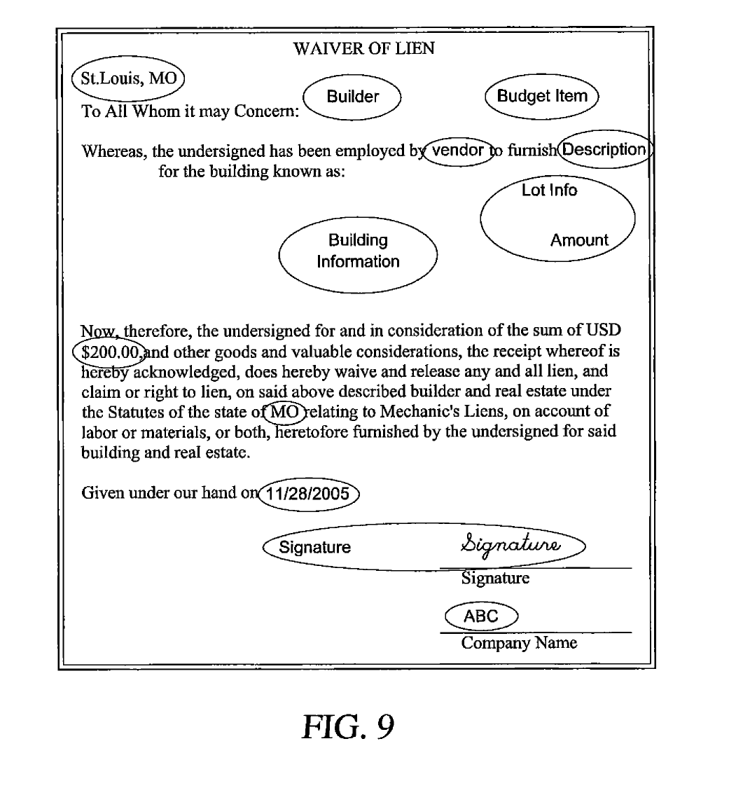

Another exemplary lien waiver is shown in FIG. 8. As a particularly valuable feature of the present invention, lien waivers are automatically created by the eCommerce system of the present invention utilizing information about the parties already stored within the eCommerce system. For example, vendor identification information, the services rendered by that vendor, the amount charged by the vendor, etc., are already stored within the eCommerce system via the electronic purchase order. Such information then may be automatically included within the lien waiver. Builder and project specific information also are included within the lien waiver. For example, FIG. 9 illustrates an exemplary lien waiver automatically generated wherein at least the items circled represent data previously supplied to and stored within the eCommerce system of the present invention. In a particular variation, the signature of the vendor (or a person authorized to sign for the vendor) is previously supplied to the eCommerce system.

In one particular variation of the present invention, vendors are required to pre-authorize a lien waiver to be “held” (electronically) by the title company or primary lender, wherein use of the eCommerce system efficiently facilitates obtaining the pre-authorized lien waiver. Pre-authorization of a lien waiver may occur upon the vendor's acceptance of the work request or upon the vendor's approval of the electronic version of its invoice supplied back to the vendor (e.g., after the builder approves the invoice, as mentioned above).

Upon paying the vendor invoice, the lien waiver is created automatically as mentioned above and supplied via the eCommerce system to the builder. The builder then is able to access the vendor's lien waiver (e.g., by accessing the “Lien” button shown in FIG. 6) and preferably prints out a hard copy of the lien waiver for safekeeping and for submission, if necessary, to a municipality or other entity.

In another variation of the present invention, vendors do not pre-authorize a lien waiver, but rather acknowledge the receipt of payment via the eCommerce system at which time the lien waiver is automatically created for the vendor's signature. The vendor's electronic signature can be stored on the eCommerce system to enable the vendor to simply identify that a lien waiver is to be produced, at which point the eCommerce system attaches the vendor's electronic signature to the automatically generated lien waiver. For jurisdictions in which electronic signatures are not accepted, the eCommerce system prompts the vendor to print out the automatically generated lien waiver and subsequently sign it and send it to the builder.

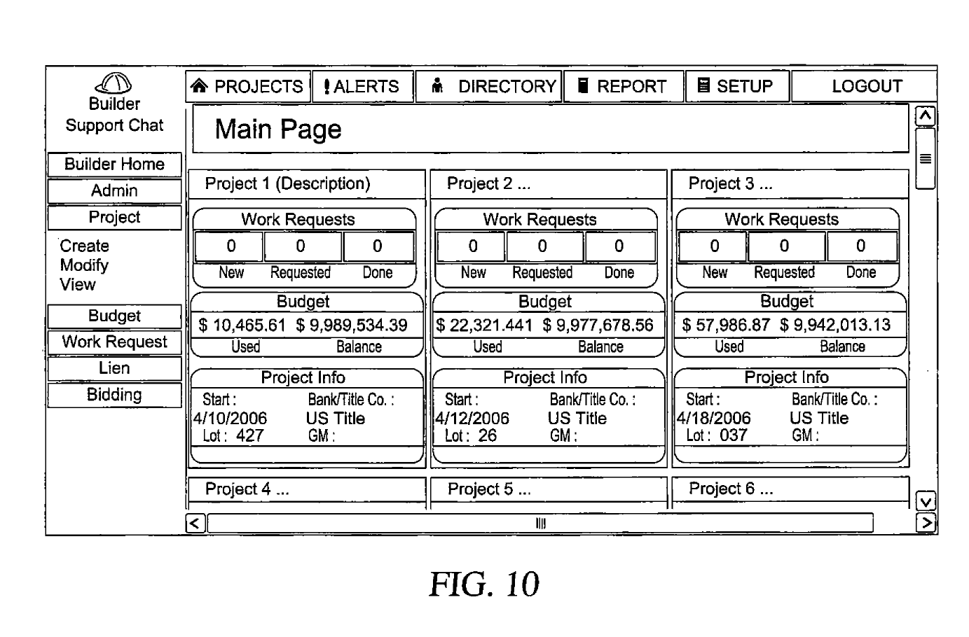

FIG. 10 shows an exemplary page of information accessible by the borrower (e.g., builder) via the eCommerce system, which identifies each of the builder's projects and select information about each of those projects. For example, the name, description and status of each of the builder's projects are readily accessible by the builder. The status of funds for each project also is readily accessible, broken down by funds already used and funds remaining. Other information provided includes project start date, lot number and bank information. By using administration functions, the builder customizes the information that is displayed. The builder selects one of the projects to access further information concerning that project including the complete budget (previously discussed), vendor lists, etc.

As a particularly useful feature of the eCommerce system, work request status information is readily accessible to the builder, as shown in FIG. 10. Work request status information shows the real time status of each of the work requests for the project of interest. As shown, the status of a work request may be “New,” indicating that the work request has not yet been acknowledged by the vendor, “Requested,” indicating that the vendor submitted the work request, and “Done,” indicating that the work is completed but not yet approved by the builder. Additional statuses of work requests may include “Completed,” indicating that the work is completed and verified by the builder, “Approved/Paid” indicating that the work is completed, approved and paid, and other statuses of use to the builder. By providing such work request status information for each of its projects, the builder readily identifies what subsequent actions are necessary. Other useful information that may be displayed pertains to budget modification requests, which are monitored by the eCommerce system. For example, the number of budget modification requests may be displayed to the builder, along with information pertaining to the history of each request.

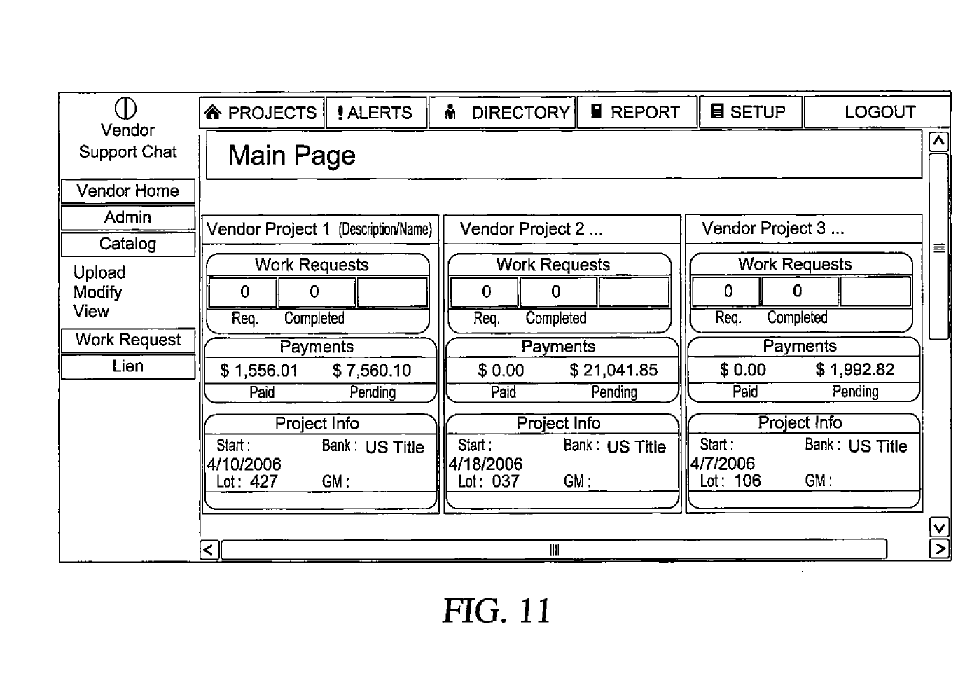

FIG. 11 shows another exemplary page accessible by a vendor via the eCommerce system, particularly identifying the multiple projects in which the vendor is involved and the status of work requests and payments for each of those projects. Work request status includes, but is not limited to, “Requested” (or “Req”), indicating newly requested work by a builder, and “Completed,” indicating the work has been approved by the builder. Other work request status may be used, such as those mentioned above that are used for the builder. The vendor also has ready access to descriptions of the projects and the name of the builder of each project. The vendor readily is able to identify whether builders need to be contacted, for example, to inquire about unanswered work requests, payments to be made, and so on. Payment information is provided in real-time and may include amounts already paid for completed work requests and amounts pending.

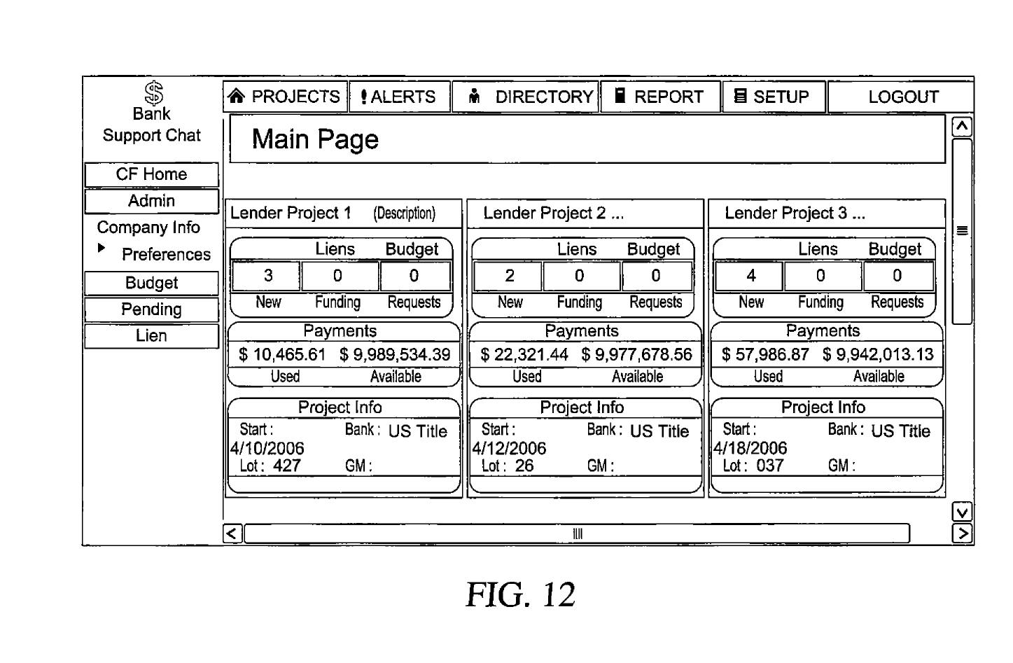

FIG. 12 shows an exemplary page accessible by the primary lender via the eCommerce system, particularly identifying various projects, budget and funding information and status. Since liens are of particular interest to the primary lender, lien status and budget modification requests are readily provided for each project. In the event multiple lenders are employing the eCommerce system of the present invention, each lender is able to access only projects for which the respective lender has provided a loan.

The eCommerce system of the present invention additionally provides for various additional automatic notifications and alerts. In particular, if the status of a work request changes, the eCommerce system automatically notifies the builder and appropriate vendor. Both the primary lender and builder also are alerted to all budget modification requests. Vendors are notified preferably by e-mail and via the eCommerce system of when they can expect to be paid upon invoice approval.

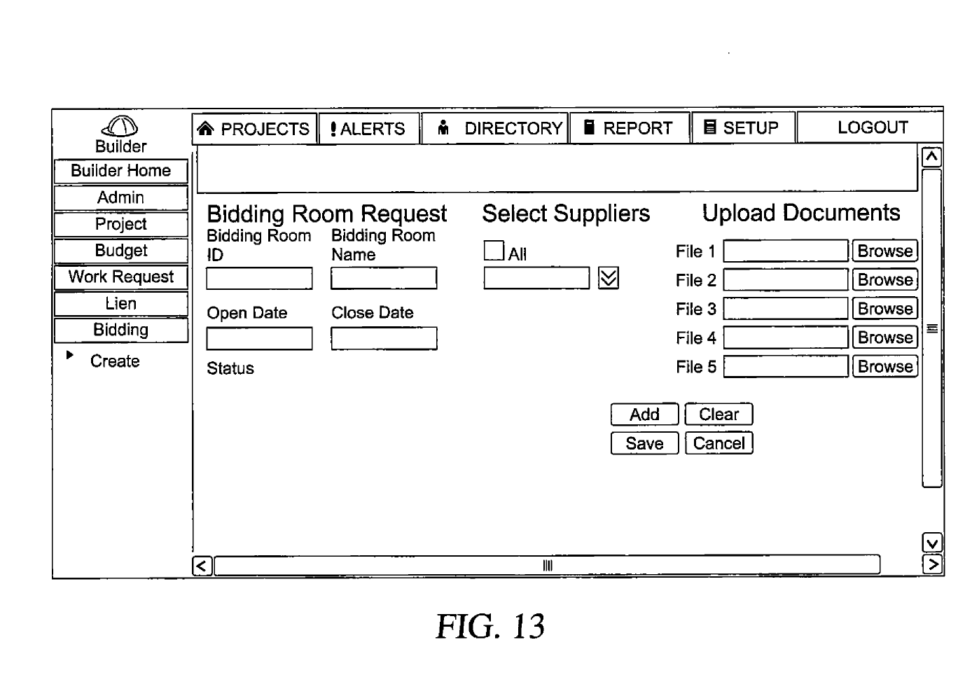

FIG. 13 shows an exemplary page accessible by the builder via the eCommerce system pertaining to online bidding by vendors in accordance with the present invention. The builder may limit the bid to select vendors or allow all vendors to bid. Preferably, the eCommerce system classifies vendors by capability (i.e., type of vendor), geography, and other criteria. In such case, the builder designates the type of task to be performed along with the location of the task, and perhaps other criteria, and the eCommerce system identifies all vendors with classifications that match the builder's specified criteria(s). Vendors access builder bid requests and submit bids to the builder through the eCommerce system of the present invention. Documents that can be submitted include blueprints, drawings, specifications, and so on. The builder approves a bid and communicates the approval to the vendor via the eCommerce system of the present invention. An additional notification to the vendor preferably is supplied, for example, in an e-mail to inform the vendor that its bid has been accepted.

Vendors may establish a relationship with the secondary lender to enable those vendors to collect payment from the secondary lender in accordance with the present invention. For example, vendors can join a program established by the secondary lender. As an option of the online bidding feature, a bid can be designated to be limited solely to those vendors that have a relationship with a particular secondary lender. In addition to such designation, other criteria can be selected. Then, by limiting a bid to vendors that already accept payment from a secondary lender in accordance with the present invention, contractors and other fund recipients readily know that any accepted bid will be from a vendor who is willing to be paid in the manners herein described.

As discussed above, it is seen that the present invention entails multiple embodiments and variations for facilitating payments to various entities during various types of projects. Various advantageous features have been described, including incentives for participating in programs implementing the present invention, speed of payment, convenience and efficiency of activities, and so on.

As another particularly valuable feature, fraud and theft are reduced by the present invention. In particular, funds are appropriated and paid directly to the vendor providing the services, for the services provided, in the manners described herein. On the other hand, in prior art processes, a borrower of a project, such as a builder, draws down on the construction loan on a percentage of completion basis, not on a specific payment basis. If a builder receives a draw for work that was performed, the draw is placed in the builder's general funds. There is no assurance that the vendor actually receives payment for the service provided, even though those services formed the basis for the percentage completion draw. In the present invention, however, vendors are third party beneficiaries of the three-party agreement between the borrower, the primary lender and the secondary lender. Once payment is approved, the secondary lender makes the payment to the vendor. In some respects, the secondary lender may be considered to be a collection agent for the vendor.

The present invention preferably employs an Internet-based application that provides real-time project (e.g., construction project) monitoring of the payment process for fund recipients, lending institutions and vendors. Programs employing the present invention add operational efficiency for the various participants in various industries. The eCommerce system of the present invention represents a “paperless environment”—Electronic Data Interchange (EDI)—with definite process benefits, such as quicker status updates, faster invoice processing, electronic lien waivers, and project-specific statistics.

The processes and apparatuses of the present invention allow a fund recipient to establish a project, vendors to develop and display and sell supplies and/or services, and lending institutes to participate and approve transactions pursuant to their lending terms. The eCommerce system connects the major players in projects, streamlines the payment process and provides participants with added value for using multiple sources of funds as described herein.

The specific embodiments described herein are illustrative of the processes and systems of the present invention. It is to be understood, however, that other expedients known to those skilled in the art or disclosed herein may be employed without departing from the spirit of the present invention. It is intended therefore that the appended claims be interpreted as including the embodiments described herein, the alternatives mentioned above, and all equivalents thereto.

1. A process of utilizing multiple sources of funds to pay expenses incurred during a project, comprising the steps of:
obtaining an invoice for payment, the invoice submitted by a vendor for rendering services for the project;
obtaining verification that funds from a primary loan are available for the invoice;
paying the invoice with funds from a secondary loan; and
repaying the secondary loan with funds from the primary loan.

2. The process of claim 1, further comprising the steps of securing the primary loan; and securing the secondary loan after the primary loan is secured.

3. The process of claim 1, further comprising the steps of securing the primary loan by a borrower; and verifying by an entity distinct from the borrower that funds from the primary loan are available for the invoice.

4. The process of claim 1, wherein the step of paying the invoice with funds from the secondary loan is carried out after obtaining verification that funds from the primary loan are available for the invoice.

5. The process of claim 1, wherein the primary loan is secured by property relating to the project.

6. The process of claim 1, further comprising the step of securing the secondary loan with a term restricting usage of the secondary loan to pay only invoices relating to the project funded by the primary loan.

7. The process of claim 1, further comprising the step of securing the secondary loan with terms permitting usage of the secondary loan to pay both pre-approved and non-approved invoices, a pre-approved invoice corresponding to an invoice in which verification that funds from the primary loan are available for the respective invoice is obtained; and a non-approved invoice corresponding to an invoice in which no verification is obtained.

8. The process of claim 7, wherein the secondary loan includes a term corresponding to no pre-set spending limit for paying pre-approved invoices, and the secondary loan includes a term corresponding to a pre-set spending limit for paying non-approved invoices.

9. The process of claim 7, wherein the secondary loan includes a term corresponding to a first pre-set spending limit for paying pre-approved invoices, and the secondary loan includes a term corresponding to a second pre-set spending limit for paying non-approved invoices, the first and second pre-set spending limits being different.

10. The process of claim 9, wherein the first pre-set spending limit is substantially greater than the second pre-set spending limit.

11. The process of claim 7, wherein the secondary loan includes a term corresponding to a first payment window during which funds borrowed from the secondary loan to pay pre-approved invoices may be paid without incurring interest; and the secondary loan includes a term corresponding to a second payment window during which funds borrowed from the secondary loan to pay non-approved invoices may be paid without incurring interest, the first and second payment windows being different.

12. The process of claim 11, wherein the first payment window is substantially shorter than the second payment window.

13. The process of claim 1, wherein the step of obtaining verification includes transferring funds from the primary loan to a separate account.

14. The process of claim 13, wherein the step of repaying the secondary loan is carried out by transferring funds from the separate account into an account corresponding to the secondary loan.

15. The process of claim 13, wherein transferring funds from the primary loan to the separate account occurs prior to the step of paying the invoice with funds from the secondary loan.

16. The process of claim 13, wherein transferring funds from the primary loan to the separate account occurs after the step of paying the invoice with funds from the secondary loan.

17. The process of claim 1, further comprising the step of obtaining authorization from a title company to pay the invoice; and the step of paying the invoice is carried out only if authorization is obtained from the title company.

18. The process of claim 17, wherein the step of obtaining authorization from the title company occurs after the step of obtaining verification that funds from the primary loan are available for the invoice.

19.-23. (canceled)

24. A process of utilizing multiple sources of funds to pay expenses incurred during a project, comprising the steps of:
obtaining an invoice for payment, the invoice submitted by a vendor for rendering services for the project;
obtaining verification that funds from a primary fund source are available for the invoice;
paying the invoice with funds from a secondary fund source; and
repaying the secondary fund source with funds from the primary fund source.

25.-44. (canceled)

45. A process of utilizing multiple sources of funds to pay expenses incurred during a project, comprising the steps of:
electronically approving an invoice submitted by a vendor for rendering services for the project;
paying the invoice with funds from a secondary fund source; and
repaying the secondary fund source with funds from the primary fund source.

46.-65. (canceled)
